(19) United States
(12) Patent Application Publication
(10) Pub. No.: US 2011/0173786 A1
(43) Pub. Date: Jul. 21, 2011

(54) Cutting analytical instrument tubing

(75) Inventors: Khosro MOSHFEGH, Fremont, CA (US); Martin Vana, Fremont, CA (US)

(73) Assignee: Dionex Corporation, Sunnyvale, CA (US)

(21) Appl. No.: 12/691,669

(22) Filed: Jan. 21, 2010

(51) Int. Cl. B26D 3/16; B26D 7/06; B26D 5/42

(52) U.S. Cl. 29/2.15; 83/401; 83/375; 83/54

(57) ABSTRACT

An apparatus for cutting analytical instrument tubing includes a blade for cutting a tube and a clamp assembly configured to securely hold at least a portion of the tube. The clamp assembly is movable between a first position to hold the tube in a first cutting location relative to the blade and a second position to hold the tube in a second cutting position relative to the blade. A tube advancement mechanism is operably connected to the clamp assembly. A method for cutting an analytical instrument tube having a first cross section and a second cross section proximal to the first cross section includes positioning the tube in a first cutting position relative to a cutting edge of a blade, at least partially cutting the tube across the first cross section to form a first cut surface, advancing the tube to a second cutting position relative to the cutting edge of the blade, and cutting the tube across the second cross section of the tube to form a second cut surface, the second cut surface having fewer imperfections than the first cut surface.

### BACKGROUND OF THE INVENTION

1. Field of the Invention

This invention relates, in general, to cutting analytical instrument tubing and more particularly to cutting apparatus and methods for their use.

2. Description of Related Art

There exist a number of different types of analytical instruments that utilize tubing for transporting, filtering, and separating analytes. Some of these instruments include and are not limited to ion chromatographs, mass spectrometry systems, gas chromatography systems, high performance liquid chromatography (HPLC) systems, and others. The types of tubing employed with each of these systems can differ slightly based on composition, internal diameter, thickness and flexibility. The tubing used for these instruments needs to be periodically replaced and is typically cut from a longer stand of tubing to provide an appropriate length. A difficulty is that the operation of these instruments can be affected by the quality of the cut.

Over time and with use, most tubing materials break down and need to be repaired. After the tubing breaks, begins to leak or wear, it can often take some time for a technician to replace or repair. This loss of production time can be costly to scientists who need to run large sample lots quickly or conduct drug screening tests that require high throughput. Therefore, various tubing has been developed that can be cut at differing lengths or sizes as appropriate for the application. Common methods and techniques for cutting tubing include manual and automated devices such a cutting device with a spinning blade to score or make a partial cut into the tubing. The extra portion or segment of tubing is then snapped-off at the score or partial cut.

A problem with this technique is that it can result in defects on the cut end, which is the cross-sectional surface formed at the end of the tube when the tube is cut and the extra segment of tubing is snapped-off. Defects include structural and physical changes in the tubing on the cross-sectional surface of the cut end, lumen surface adjacent to the cut end, or outer tubular surface adjacent to the cut end. Such defects can be observed with the naked eye or with the use of an instrument. Examples of defects include, but are not limited to, flaws, burrs, cuts, frays, cracks, chips, nicks, blemishes, gauges, artifacts, extra tubing material, stretch marks or lines, compromised materials, peaks or valleys, and varying levels of surface area height or width, whether such defects are visible to the naked eye or only with the aid of instrumentation. Defects also can include snap lines, which are lines, ridges, or other defects running across at least a portion of the surface of the cut end. Although snap lines commonly result from snapping off the extra segment of tubing at the site of a partial cut, they also can result from other processes and techniques.

FIG. 10 is a scanning electron micrograph illustrating the cross-sectional surface at the cut end of analytical instrument tubing formed with PEEK. The cross-sectional surface was formed by the prior art cutting technique of making a partial cut using a spinning blade and then snapping off the extra segment of tubing. The image of the cross-sectional surface in the micrograph has a magnification of 4950×.

A related problem is that such defects in analytical instrument tubes can cause zero void volumes, which are empty volumes at the point where the tube is connected to the instrument with ferrules or other structures. Zero void volumes can negatively impact the performance of instrumentation such as chromatography equipment by affecting fluid flow and the retention time of fluids. For chromatography, the defects can affect the position, shape, width, and height of chromatography peaks. Defects also can negatively affect the performance of other instrumentation in addition to chromatography.

In addition, imperfectly cut or finished tubing under high pressure will quickly magnify leaks, loss of sample, or even cause instrument failure. Yet another problem with existing cutting tools is that they can be quite large, unwieldy, or difficult to use.

### BRIEF SUMMARY OF THE INVENTION

In general terms, this patent document relates to an apparatus and method for cutting tubing used with analytical instruments.

One aspect is an apparatus for cutting analytical instrument tubing. The apparatus comprises a blade for cutting a tube. A clamp assembly is configured to securely hold at least a portion of the tube. The clamp assembly is movable between a first position to hold the tube in a first cutting location relative to the blade and a second position to hold the tube in a second cutting position relative to the blade. A tube advancement mechanism is operably connected to the clamp assembly.

Another aspect is a method for cutting an analytical instrument tube having a first cross section and a second cross section proximal to the first cross section. The method comprises positioning the tube in a first cutting position relative to a cutting edge of a blade; at least partially cutting the tube across the first cross section to form a first cut surface; advancing the tube to a second cutting position relative to the cutting edge of the blade; and cutting the tube across the second cross section of the tube to form a second cut surface, the second cut surface having fewer imperfections than the first cut surface.

### BRIEF DESCRIPTION OF THE DRAWINGS

FIG. 1 is a top orthogonal view of a cutting tool for cutting analytical instrument tubing.

FIG. 2 is a bottom orthogonal view of the cutting tool shown in FIG. 1.

FIG. 3 is an exploded view of the cutting tool shown in FIG. 1.

FIG. 4 is a cross-sectional view, taken along line 4-4, of a clamp assembly, sleeve, and support structure shown in FIGS. 1-3.

FIGS. 5A and 5B are bottom orthogonal views illustrating rotation of the clamping assembly shown in FIGS. 1-3.

FIG. 6 is a top orthogonal view of components of a cutting assembly shown in FIGS. 1-3.

FIG. 7 illustrates the blade shown in FIGS. 1-3 cutting analytical instrument tubing.

FIGS. 8A-8C illustrates movement of the cutting assembly shown in FIGS. 1-3 while cutting analytical instrument tubing.

FIG. 9 is a top plan view of an automated embodiment of the cutting tool shown in FIGS. 1-3.

FIG. 10 is a scanned electron micrograph illustrating the cut end of analytical instrument tubing using the prior art and defects in the cut end resulting from the cut.

FIG. 11 is a scanned electron micrograph illustrating the cut end of analytical instrument tubing using the cutting tool shown in FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Within this patent document, the conjunction “or” connotes “and/or” unless stated otherwise or the use of the conjunction “and/or” is clearly inappropriate. The indefinite articles “a” and “an” connotes “one or more” unless stated otherwise or where the use of “one or more” is clearly inappropriate. Additionally, qualifiers such as “about” and “substantially” connotes physical structures, physical relationships, and values for given measurements, parameters, ranges, and the like, can vary due to differences in manufacture tolerances and conditions of use.

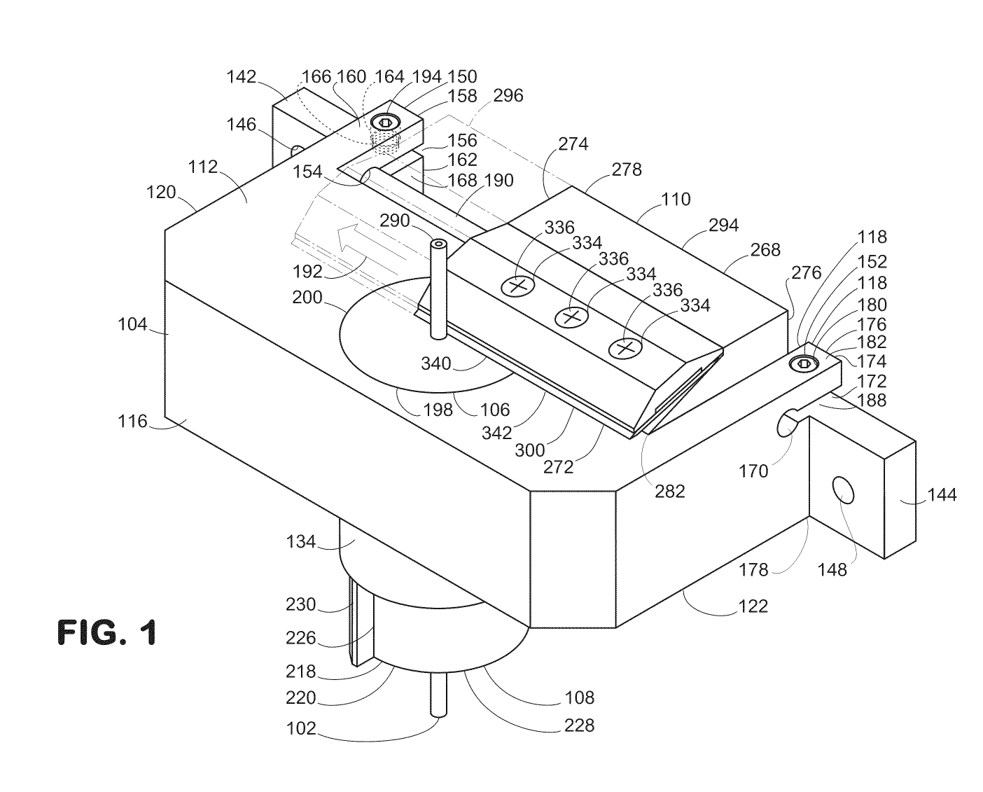

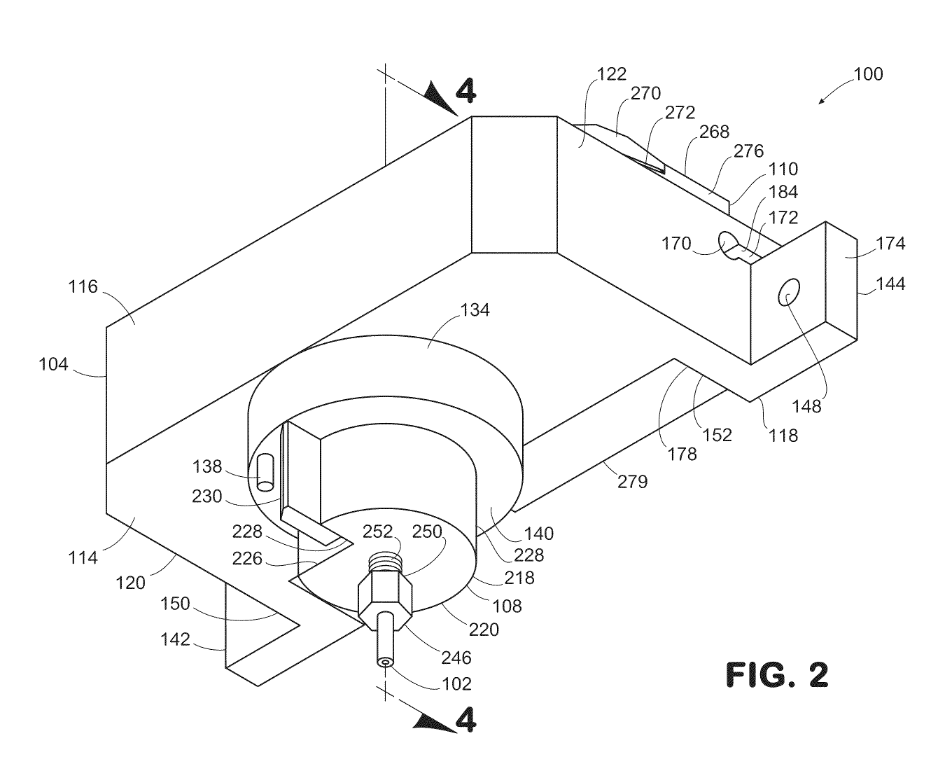

FIGS. 1-3 illustrate one of the many possible embodiments of a cutting tool 100 for cutting tubing 102 such as analytical instrument tubing. The cutting tool 100 includes a support structure 104 that supports a sleeve 106, a clamp assembly 108, and a cutting assembly 110. The support structure 104 has a top portion 112, bottom portion 114, front portion 116, rear portion 118, and first and second oppositely disposed side portions 120 and 122. A sleeve hole 124 is defined through the support structure 104 and is centered on a centerline 126. The sleeve hole 124 extends through the support structure 104 and between the top and bottom portions 112 and 114. The sleeve hole 124 has an upper portion 128 having an upper diameter and a lower portion 130 having a lower diameter smaller than the upper diameter, thereby forming a lip 132 that extends around the circumference of the sleeve hole 124. The lip 132 faces the top portion 112 of the support structure 104.

A collar 134 defines a collar hole 136 and is connected to the bottom surface 114 of the support structure 104 so it does not rotate relative to the support structure 104. The collar hole 136 is centered on the centerline 126 and is axially aligned with the sleeve hole 124 in support structure 104. A stop 138 projects from a bottom surface 140 of the collar 134. The diameter of the collar hole 136 is smaller than the diameter of the lower portion 130 of the sleeve hole 124. As explained in more detail herein, the lip 132, sleeve hole 124, and collar 134 support the clamp assembly 108.

A first mounting flange 142 extends from the first side portion 120 of the support structure 104 and a second mounting flange 144 extends from the second side portion 122 of the support structure 104. The first and second mounting flanges 142 and 144 each define a hole 146 and 148, respectively, for receiving bolts, pins, or other mounting fasteners. The first and second mounting flanges 142 and 144 face and are proximal to the rear portion 118 of the support structure 104 and can be used to selectively mount the cutting tool 100 to a bench top, fixture, or any other suitable structure for holding the cutting tool 100. The cutting tool 100 can include any other mounting structure suitable for mounting the support structure 104 in a secure portion. Alternatively, the cutting tool 100 can not include any mounting structure. A user can use the cutting tool 100 by either mounting the cutting tool 100 on another structure such as a bench top or by holding the support structure 104 in their hand.

First and second support flanges 150 and 152 extend from the rear portion 118 of the support structure 104. The first support flange 150 is proximal to the first side portion 120 and defines a bar hole 154 and a slot 156 that extends from the bar hole 154 to a rear surface 158 of the first support flange 150. The slot 156 defines top and bottom portions 160 and 162 of the first support flange 150. A non-threaded hole 164 is defined in the top portion 160 of the first support flange 150 and extends from a top surface of the first support flange 150 to an upper surface 164 of the slot 156. A threaded bolt hole (not shown) is defined through a bottom surface 168 of the slot 156 and into the bottom portion 162 of the first support flange 152 and is axially aligned with the non-threaded hole 164. The second support flange 152 is proximal to the second side 122 and also defines a bar hole 170 and a slot 172 that extends from the bar hole 170 to a rear surface 174 of the second support flange 152. The slot 172 defines top and bottom portions 176 and 178 of the second support flange 152. A non-threaded hole 180 is defined in the top portion 176 of the second support flange 152 and extends from a top surface 182 of the second support flange 152 to an upper surface 184 of the slot 172. An axially-aligned threaded bolt hole (not shown) is defined through a bottom surface 188 of the slot 172 and into the bottom portion 178 of the second support flange 152 and is axially aligned with the non-threaded hole 180.

A bar 190 extends through the bar hole 154 in the first support flange 150, across the gap between the first and second support flanges 150 and 152, and into the bar hole 154 in the second support flange 152. A bolt 194 passes through the non-threaded hole 164, across the slot 156 in the first support flange 150, and is threaded into the threaded bolt hole of the first support flange 150. The bolt 194 urges the top and bottom portions 160 and 162 of the first support flange 150 together to secure the bar 190 in the bar hole 154 with a frictional fit. A second bolt 196 is similarly passes through the non-threaded hole 180, passes across the slot 172, and is threaded into the threaded bolt hole of the second support flange 152.

Referring now to FIGS. 1-4, the sleeve 106 has a top end that forms a substantially flat cutting surface 200. A rim 198 circumscribes the circumference of the top end and the upper surface of the rim 198 forms part of the substantially flat cutting surface. A cylindrical wall 202 extends from a bottom portion of the rim 198 to an end portion 204. The cylindrical wall 202 has an inner surface 206 that defines a threaded clamp assembly hole 208 centered on the centerline 126. The threaded clamp assembly hole 208 has an open end 210 at the end portion 204 of the cylindrical wall 202 and a closed end 212. The sleeve 106 also defines a first tube passage 214 that is centered on the centerline 126 and that extends from the closed end 212 of the threaded clamp assembly hole 208 to a tube hole 216 defined in the cutting surface 200. The diameter of the first tube passage 214 is smaller than the diameter of the threaded clamp assembly hole 208.

The clamp assembly 108 includes a clamp member 218 having a base 220 and a rod 222 projecting from the base 220 and toward the sleeve 106. The rod 222 is centered on the centerline 126 and defines threads 224 sized and arranged to mate with the threads 207 on the inner surface 206 of the sleeve 106. The threads 222 are left-handed threads. The threads 224 on the rod 222 and the mating threads 207 on the inner surface 206 of the sleeve 106 form a tube advancement mechanism, which is discussed in more detail herein.

The threads 224 on the rod 222 have a major diameter that is smaller then the collar hole 136 so the rod 222 will fit freely through the collar hole 136 and into the clamp assembly hole 208 of sleeve 106. The base 220 defines a notch 226 in its sidewall 228 that extends radially toward the centerline 126. A tab 230 is attached to the base 220 and extends radially from the notch 226. The notch 226 and tab 230 provide a location for a person to grip or otherwise engage and rotate the clamp assembly 108 with a thumb or finger.

The clamp member 218 has an inner surface 232 with threads 234 that defines a bolt hole 236. The bolt hole 236 is centered on the centerline 126 and has an open end 238 at the base 220 and a closed end 240 positioned along the centerline 126. The clamp member 218 also defines a second tube passage 242 that is centered on the centerline 126 and that extends between the closed end 240 of the bolt hole 236 and the end 238 of the threaded rod 222. The diameter of the bolt hole 236 is larger than the diameter of the second tube passage 242. The closed end 240 of the bolt hole 236 has a tapered portion 244 that tapers toward the second tube passage 242 and has a circular conic shape. The closed end 240 of the bolt hole 236 forms a first ferrule seat.

The clamp assembly 108 also includes a clamp bolt 246 and a ferrule 248. The clamp member 218 forms a first clamp member and the clamp bolt 246 forms a second clamp member. The ferrule 248 forms a compression fitting. The clamp bolt 246 has a bolt head 250 and a threaded shaft 252. The threads 254 on the threaded shaft 252 are sized and arranged to mate with the threads 234 on the inner surface 232 of the bolt hole 236. The clamp bolt 246 defines a third tube passage 254 that is centered on the centerline 126 and extends all the way through the bolt head 250 and the threaded shaft 252. The end of the third tube passage 254 has a tapered portion 256 that tapers toward the centerline 126 from the end 258 of the threaded shaft 252 toward the bolt head 250 to provide a circular conic shape and form a second ferrule seat. The ferrule 248 has an inner surface 260 defining a fourth tube passage 262. The ferrule 248 also has a first outer surface 264 having a circular conic section that sits in the first ferrule seat and a second outer surface 266 having a circular conic section that sits in the second ferrule seat. The first, second, third, and fourth tube passages 214, 242, 254, 262 have substantially the same diameter and form a tube passage.

When the sleeve 106 and the clamp assembly 108 is assembled, the sleeve 106 is positioned in the support structure 104 hole so that the bottom of the rim 198 is resting against the lip 132 and the cutting surface lies substantially in the same plane as the top surface of the support structure 104. Additionally, the outer circumference of the rim 198 is slightly smaller than the upper diameter of the sleeve hole 124 so there is minimal gap between the rim 198 and the support structure 104. The rod 222 from the clamp member 218 is inserted through the collar hole 136 and is threaded to the threads 207 on the inner surface 206 of the sleeve 106. The clamp bolt 246 is threaded into the third tube passage 254. The ferrule 248 is positioned so the first outer surface 264 is positioned against the first ferrule seat and the second outer surface 266 is positioned against the second ferrule seat.

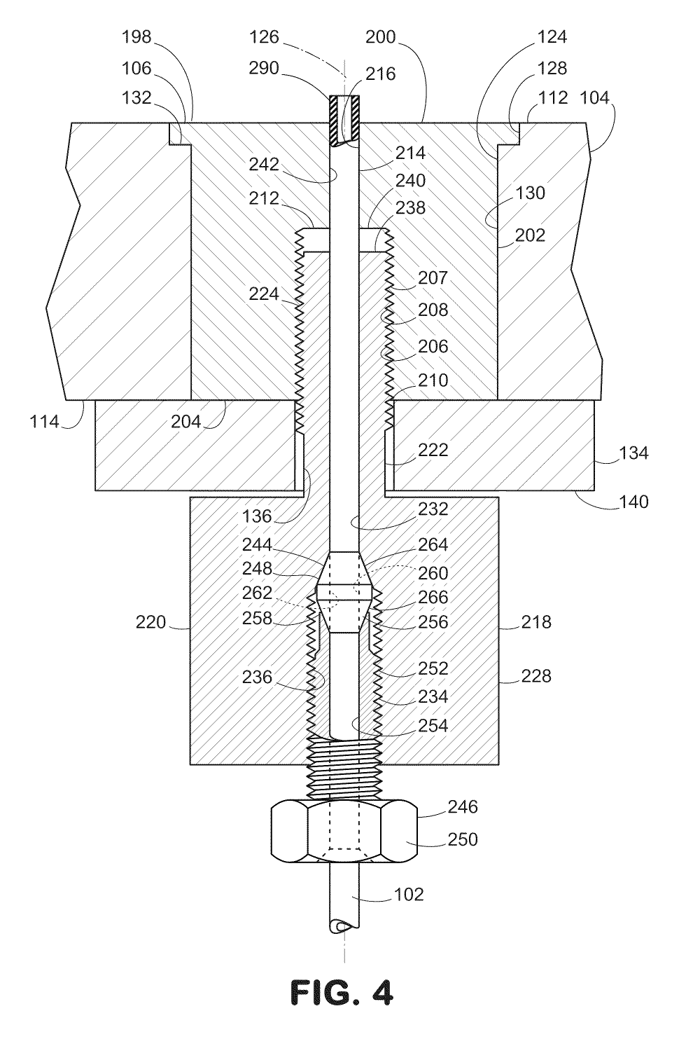

Referring to FIG. 4, tubing 102 is mounted in the cutting tool 100 by inserting the tubing 102 through the tubing passage 214, 242, 254, 262 so that a segment 290 of the tubing 102 projects through the tube hole 216 in the cutting surface 200 and extends beyond the cutting surface 200. Tubing can be any structure that forms a conduit for carrying fluids. Furthermore, the tubing can be rigid, flexible, compressible, or non-compressible. Example materials for forming the tubing 102 includes, but are not limited to, plastic, metal, steel, ceramic, glass, epoxy, polymeric materials, thermoplastic materials, semi-crystalline materials, polycrystalline materials, tubing can comprise a material selected from the group consisting of silica, fused silica, silicone, acetal resin, and resin. More specific examples, of material that can be used to form tubing 102, includes but are not limited to, polymeric materials such as polyetheretherketone (PEEK), epoxy, polyimide (PI), polytetrafluoroethylene (PTFE), ethylene-chlorotrifluorethylene (ECTFE), polyphenylsulfone (PPSU), ismaprene, fluoroethylene-propylene (FEP), perfluoralkoxy (PFA), ethylene-tetrafluoroethylene-copolymer (ETFE), polyetherimide (PEI), polyamide-imide (PAI), polyphenylene sulfide (PPS), polysulfone (PSU), polypropylene, polyvinyl-fluoride (PVF), polyvinylidene-fluoride (PVDF), polyetherimide (PEI), polyetheretherketone with fused silica, polychlorotrifluoroethylene (PCTFE), polyoxy-methylene, and acetyl polyoxy-methylene. Additionally, the tubing 102 can have any inner and outer diameter suitable for use with analytical instruments. Examples of suitable inner diameters include, are in a range of about 1/32 inch to about ½ inch (0.7937 millimeters to 12.69 millimeters) and include the standard inner diameters of about 1/32 (0.7937 millimeters), 1/16 (1.587 millimeters), ⅛ (3.174 millimeters), ¼ (6.34 millimeters), and ½ (12.69 millimeters) of an inch.

After a sufficient length of tubing is inserted through the tube passage 214, 242, 254, 262, the clamp bolt 246 is sufficiently tightened so that the first outer surface 264 of the ferrule 248 is urged against the first ferrule seat and the first ferrule seat compresses a portion of the inner surface 260 of the ferrule 248 against the tube 102. This compression holds the tube 102 in a secure position relative to the ferrule 248 and prevents the tube 102 from slipping along the centerline 126. The second outer surface 266 of the ferrule 248 is urged against the second ferrule seat to similarly compress a portion of the inner surface 260 of the ferrule 248 against the tubing 102.

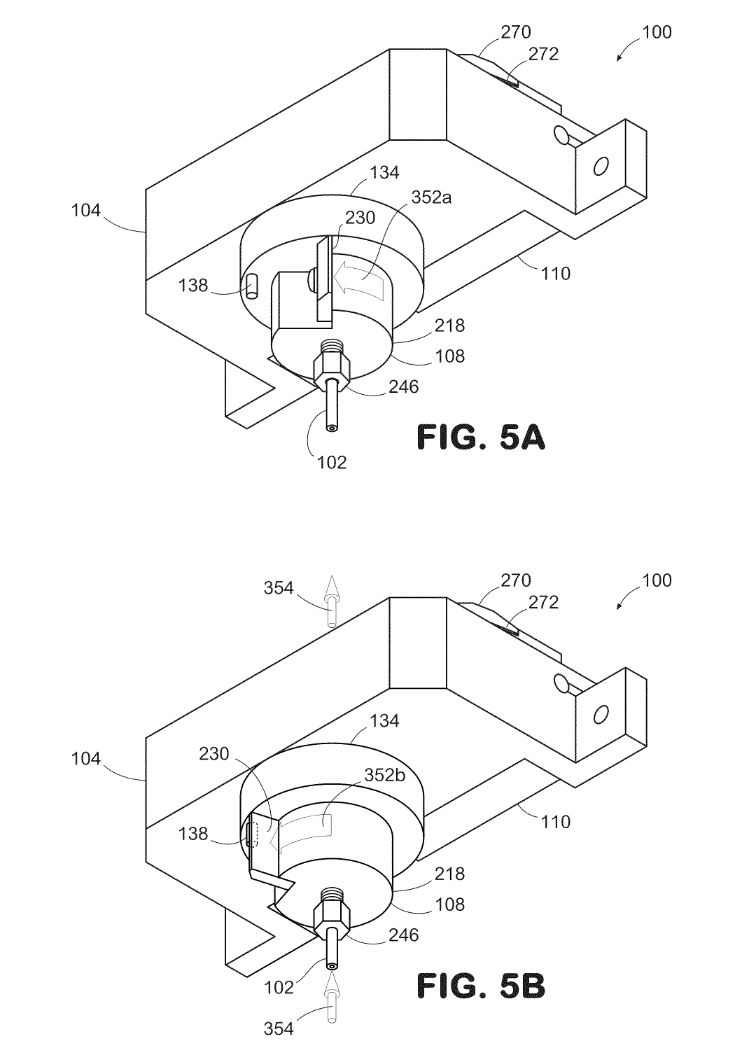

Referring to FIGS. 5A and 5B, the tube advancement mechanism advances the tubing 102 through the tube hole 216 from a first cutting position to a second cutting position by rotating the clamp member 218, and hence the clamp assembly 108, from a first rotational position 352ₐ to a second rotational position 352_{b} where the tab 230 is positioned against the stop 138. Because of the helical threads on the rod 222 and on the inner surface 206 of the sleeve 106, the rotating motion of the clamp assembly 108 causes linear advancement or displacement of the clamp member, clamp bolt, and ferrule along the centerline 126 and further extends the tube out of the tube hole. The stop limits rotation of the clamp member, clamp bolt, and ferrule. As discussed in more detail herein, a first cut is made across a cross section of the tube 102 when the clamp member 218 is in the first rotational position 352ₐ and the tube 102 is in the first cutting position. A second cut is made across a cross section of the tube 102 when the clamp member 218 is in the second rotational position 352_{b} and the tube 102 is in the second cutting position.

In an exemplary embodiment, the angle of rotation between the first and second rotational positions 352ₐ and 352_{b} translates to a linear advancement distance of the tube 102 from the first cutting position to the second cutting position in a range from about 0.0001 mm to about 10 mm. Other possible embodiments have a different distance between the first and second cutting positions. Examples of other possible ranges, include but are not limited to, about 0.001 mm to about 0.009 mm (about 0.001 to about 0.009 inch), about 0.001 to about 0.01 mm, and about 0.001 mm to about 1 mm. A linear advancement distance for the tube 102 that provides a substantially defect free surface after the second cut can very depending on a variety of factors such as the cross-sectional area of the tube 102, the material used to form the tube 102, other physical characteristics of the tube, the sharpness of the cutting edge for the blade, the angle of the blade relative to the cutting surface, the speed at which the blade travels when cutting the tube 102, and the like. Additionally, the distance of linear advancement for the tube 102 per degree of rotation for the clamp member 218 will depend on the thread angle for the threads 224 on the rod 222.

Many other alternative embodiments of the tube advancement mechanism are possible. For example, the threads on the rod 222 could mate with threads defined on an inner surface of the support structure 104 thereby negating the need for the sleeve 106. In this alternative embodiment, the cutting surface would be formed on the top portion of the sleeve 106 assembly. Other alternative tube advancement mechanisms could include other thread configurations, gearing mechanisms, lever arrangements, or any other structure that can move the clamp assembly 108 between first and second positions, and the tube between first and second cutting positions, as described in more detail herein.

Referring to FIGS. 1-3 and 6, the cutting assembly 110 includes a blade mounting structure 268 that forms a carriage, a blade clamp 270, and a blade 272. The blade mounting structure 268 has first and second side surfaces 274 and 276, a bottom surface 279, and a top surface 278. The blade mounting structure 268 also has a beveled surface 280 that slopes from the top surface down to an edge 282. A bar hole 284 is defined through the blade mounting structure 268 and extends between the first and second side surfaces 274 and 276. A first bushing 286 is inserted into the bar hole 284 with a secure frictional fit and positioned proximal to the first side surface 274, and a second bushing 288 is inserted into the bar hole 284 with a frictional fit and is positioned proximal to the second side surface 276. The bar 190 extends through the bar hole 284 and the first and second bushings 286 and 288 so that blade mounting structure 268 is slidably and rotatably mounted to the support structure 104. The bar 190 defines a linear path of travel 192 for the cutting assembly 110.

In this configuration, the cutting assembly 110 slides along the linear path of travel 192 and between a retracted position 294 (as shown in FIG. 1) in which the cutting assembly 110 is adjacent the second side portion 122 of the support structure 104 and an advanced position 296 (as shown in FIG. 1) in which the cutting assembly 110 is adjacent the first side portion 120 of the support structure 104. When the cutting assembly 110 is in the retracted position 294, the tube hole 216 is located between the first and second side surfaces 274 and 276 of the blade mounting structure 268. The cutting assembly 110 also rotates around a centerline of the bar 190 between a cutting position in which a cutting edge 300 of the blade 272 is at least partially over the tube hole 216 and engages the tubing 102 and a loading position in which the blade 272 is retracted away from the tube hole 216 and the tubing 102 can freely move through the tube hole 216 without engaging the blade 272.

In possible alternative embodiments, the tube hole 216 is located between the first side surface 274 of the blade mounting structure 268 and the first side portion 120 of the support structure 104 when the cutting assembly 110 is in the retracted position 294. In these alternative embodiments, the tube hole 216 is not obstructed when the cutting assembly 110 is in the retracted position 294 and the cutting assembly 110 does not need to be rotated into the loading position to move or advance the tube 102 though the tube hole 216.

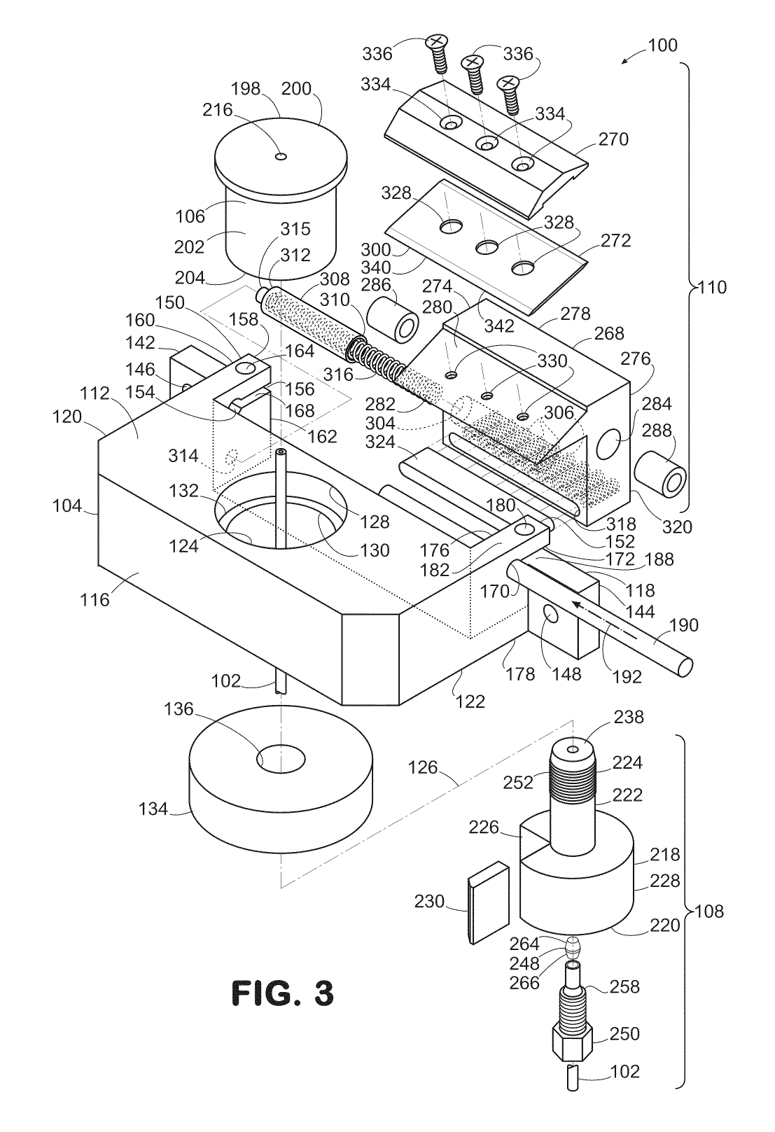

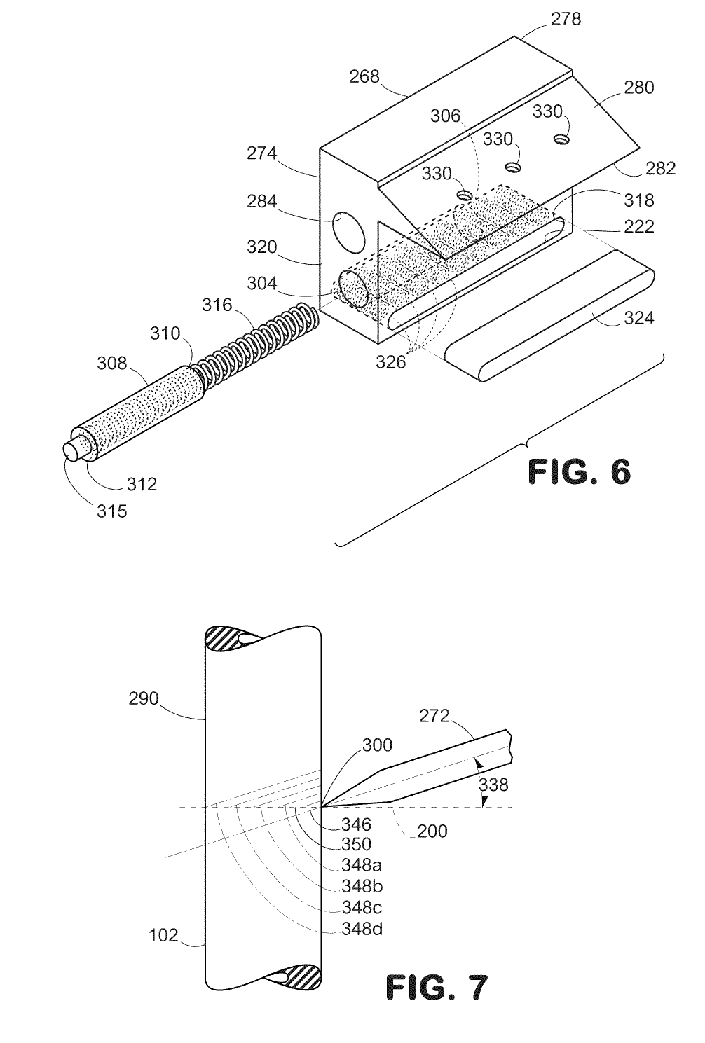

Referring to FIGS. 3 and 6, a spring hole 304 is defined in the blade mounting structure 268 and extends from the first side surface 274 to an end surface 306 internal to the blade mounting structure 268. A tubular cap 308 has an open end 310 and a closed end 312 and a nub 315 extends from the close end 312. The open end 310 of the tubular cap 308 is inserted into the spring hole 304. The closed end 312 extends from the spring hole 304 and the nub 315 projects into a hole 314 defined in the blade mounting structure 268. A helical spring 316 is positioned in the tubular cap 308 and the spring hole 304 so it extends between the closed end 312 of the tubular cap 308 and the end surface 306 of the spring hole 304. The lengths of the tubular cap 308, spring hole 304, and spring 316 are set so that the spring 316 is compressed regardless of whether the cutting assembly 110 is in the retracted position 294 or the advanced position 296. In this configuration, the spring 316 urges the cutting assembly 110 into the retracted position 294.

An elongated slot 318 is defined in a lower portion 320 of the blade mounting structure 268 and is positioned between the bar hole 284 and the bottom surface 279 of the blade mounting structure 268. The elongated slot 318 is open on a surface of the lower portion 320 of the blade mounting structure 268 and extends to an inner surface 322. An elongated pressure member 324 is inserted lengthwise into the slot. One or more springs 326 are positioned in the elongated slot 318 between the elongated pressure member 324 and the inner surface 322. The springs 326 urge the cutting assembly 110 around the bar 190 and into the cutting position.

The blade 272 is substantially flat has a cutting edge 300 and a flat surface of the blade 272 is positioned against the beveled surface 280 of the blade mounting structure 268. The cutting blade 300 can be designed in various shapes and sizes. For example, the thickness of the blade in some possible embodiments is in a range about 0.004 to about 0.012 mm. Other possible embodiments of the blade might have a thickness outside of this range. The blade can be formed with any material suitable for cutting analytical instrument tubing. Examples of such materials include, but are not limited to, glass, ceramic, steel, stainless steel and carbon.

Alternative embodiments can include more than one blade. For example, one blade can be used to make the first cut and another blade can be used to make a second cut. In these embodiments, the blades used for each cut can have different structures and positioning relative to the tube hole 216. For example, one blade might have one angle relative to the cutting surface 200 and the other blade might have a different angle relative to the cutting surface. In yet other possible embodiments, the blade has two cutting edges orientated at an angle, with the apex of the angle pointing toward the front portion 116 of the support structure 104. In these later embodiments, the first cut is made as the cutting assembly moves from the retracted position to the advanced position, and the second cute is made as the cutting assembly 110 returns from the advanced position to the retracted position.

The blade 272 defines holes 328 that are aligned with bolt holes 330 defined through the beveled surface 280. The blade clamp 270 defines holes 334 and is positioned over the blade 272 so the clamp plate holes 334 are aligned with the blade holes 328 and the bolt holes 330. Bolts 336 extend through the holes 334, 328, 330 and securely fasten the blade 272 between the blade clamp 270 and the beveled surface 280 of the blade mounting structure 268. The blade clamp 270 distributes the force exerted by bolts 336 across the surface of the blade 272. The blade clamp 270 can be formed with any suitable material. Examples of materials include, but are not limited to, TEFLON® brand fluoropolymers such as polytetrafluoroethylene (PTFE), metal materials, plastic materials, glass materials, and ceramic materials.

Referring to FIG. 7, the blade 272 is at a cutting angle 338 relative to the cutting surface 200 and is positioned so the cutting edge 300 extends beyond the edge 282 of the beveled surface 280 and lies against the cutting surface 200. In various embodiments, the cutting angle 338 is about 15°. In other embodiments, the cutting angle is in possible ranges of about 1° to about 5°, about 1° to about 15°, about 1° to about 45°, and about 1° to about 60°. Still other possible embodiments have a cutting angle 338 outside of these ranges.

Referring back to FIGS. 1-3, at least a portion of the cutting edge 300 is positioned on an opposite side of the centerline 126 of the tubular hole 216 than the bar 190. The cutting edge 300 has a leading portion 340 toward the first side surface 274 of the blade mounting structure 268 and a trailing portion 342 toward the second side surface 276 of the blade mounting structure 268. The bar hole 284 is orientated at an angle 344 relative to the edge 282 of the beveled surface 280 so the trailing portion 342 of the cutting edge 300 extends farther across the cutting surface 200 and farther beyond the centerline 126 of the tube hole 216 than the leading portion 343 of the cutting edge 300. In this configuration, the cutting edge 300 is at an angle relative to the linear path of travel 292 for the cutting assembly 110.

In use, the cutting assembly 110 is placed in the retracted position 294 along the bar 190 and is rotated around the bar 190 into the loading position. As illustrated in FIG. 4, tubing 102 is inserted through the tube passage 214, 242, 254, 262 so a segment 290 of the tubing 102 extends through the tube hole 216 and past the cutting edge 300 of the blade 272. The clamp bolt 246 is tightened to compress the ferrule 248 against the tube 102 and secure the tube 102 in position along the centerline 126. The segment 290 of the tubing 102 extending from the tube hole 216 and proximal to the cutting surface 200 is centered on the centerline 126 and is substantially perpendicular to the cutting surface 200. In this position, the tube 102 has a cross section that is substantially parallel to the cutting surface 200 and perpendicular to the centerline 126.

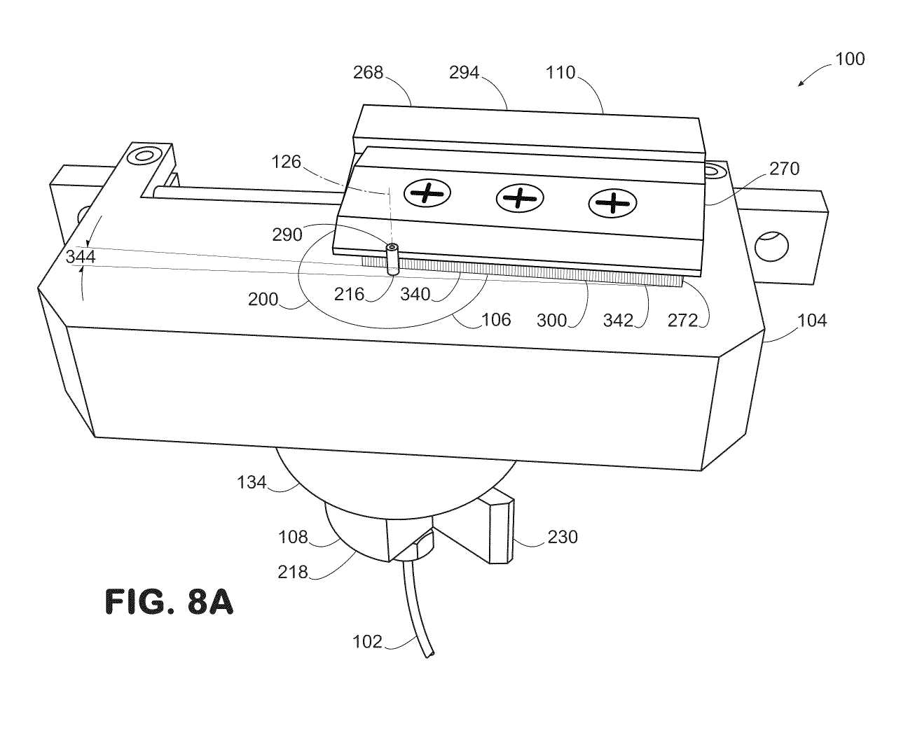

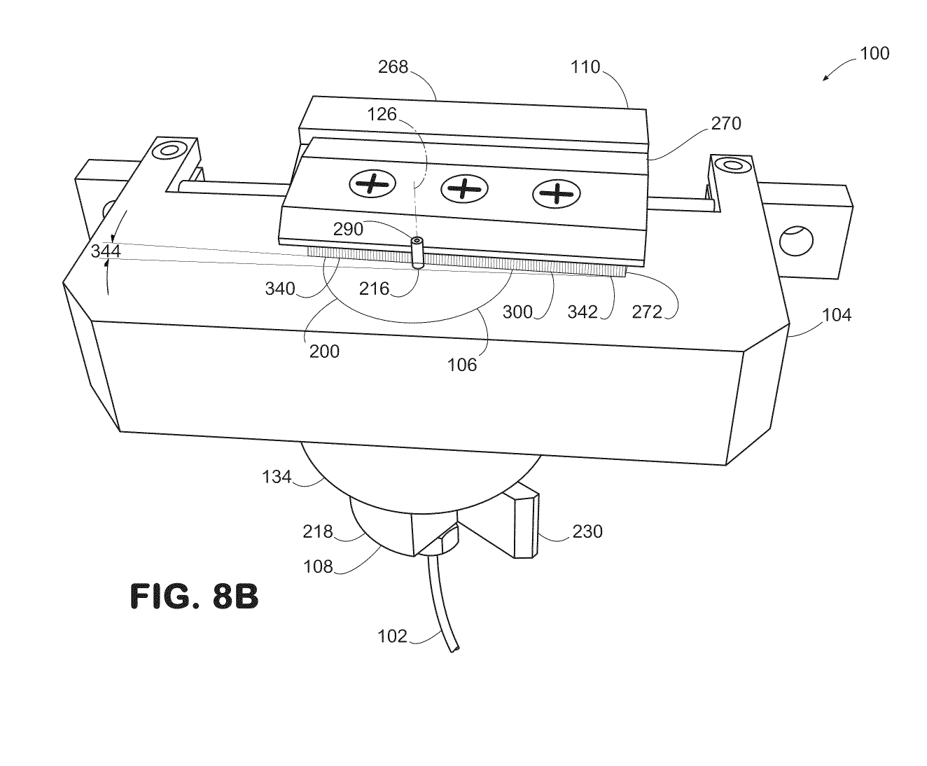

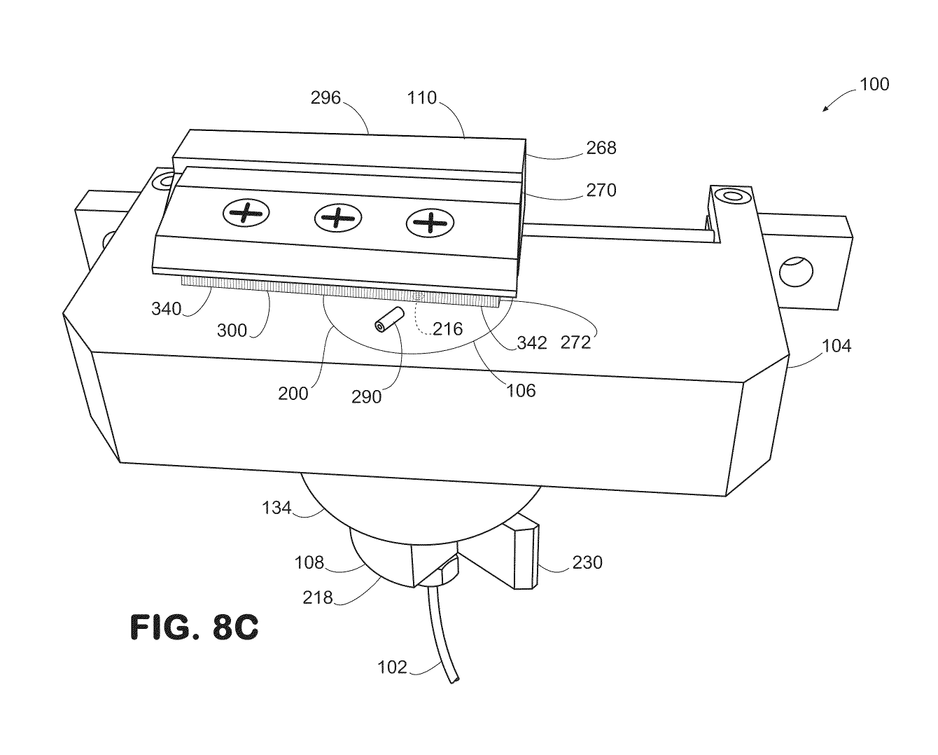

As illustrated in FIG. 5A, the clamp member 218 is rotated to the first rotational position 352ₐ. Referring now to FIGS. 7 and 8A-8C, the cutting assembly 110 is then rotated around the bar 190 into the cutting position so the leading portion 340 of the cutting edge 282 of the blade 272 makes an initial cut 346 that extends partially across the cross section 350 of the tubing 102. The cutting assembly 110 is then slid from the retracted position 294 to the advanced position 296 to make a first cut. As the cutting assembly 110 slides toward the advanced position 296, and because of the cutting angle 338 of the cutting edge 282 relative to the linear path of travel 292 for the cutting assembly 110, the cutting edge 282 will gradually cut father across the cross section of the tube 102 until the cutting edge 282 cuts completely across the cross section of the tube 102 and the extended segment 290 of the tube 102 is fully cut from the tube 102. Advancement of the cutting edge 282 across the cross section of the tubing 102 is illustrated in FIG. 7 by sequential cutting blade positions 348ₐ, 348_{b}, 348_{c}, 348_{d} that occur as the cutting assembly 110 moves from the retracted position 294 to the advanced position 296. In alternative embodiments, the first cut is only a partial cut and is not cut all the way across the cross-section of the tube 102.

After the first cut is complete, the cutting assembly 110 is returned to the retracted position 294 and rotated around the bar into the loading position. While the cutting assembly 110 is in the loading position, the clamp assembly 108 is rotated to the second rotational position 352_{b}, which causes the tube 102 to advance through the tube hole 216 into the second cutting position. The cutting process is then repeated and the tube 102 is cut a second time. This repeated process again includes the acts of rotating the cutting assembly 110 around the bar 190 and into the cutting position and then moving the cutting assembly 110 to the advanced position 296 to make a second cut across the cross section of the tubing 102.

After the second cut, the cut end of the tube 102 has a substantially flat cross-sectional area that is substantially defect free. Examples of a substantially flat surface include cross-sectional areas that deviate from a plane orthogonal to the centerline 196 of the tube 102 by an amount of about 1 micrometer or less, by an amount of about 10 micrometers or less, by an amount of about 100 micrometers or less, or by an amount of about 1000 micrometers or less. Examples of substantially defect free surface at the cut end include a cross-sectional surface that has about 10 or fewer defects per square micrometer, about 20 or fewer defects per square micrometer, about 100 or fewer defects per square micrometer, or about 1000 or fewer defects per square micrometer. Analytical instrument tubes having a cut end with a substantially flat cross-sectional area that is substantially defect free can be connected to analytical instruments with minimal zero-void volumes.

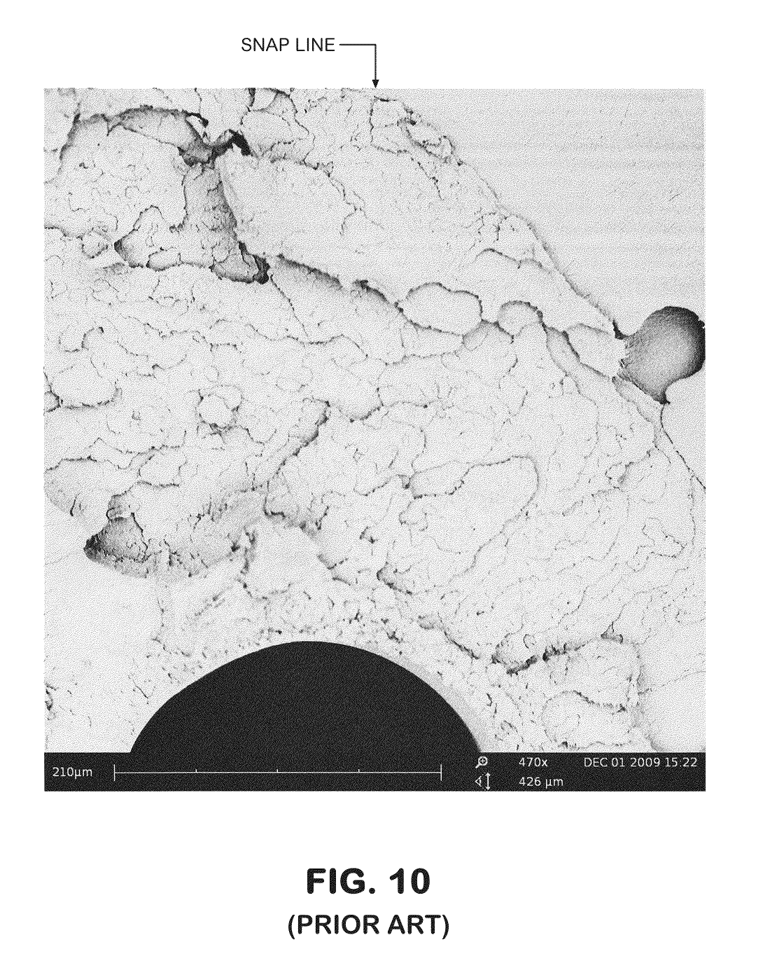

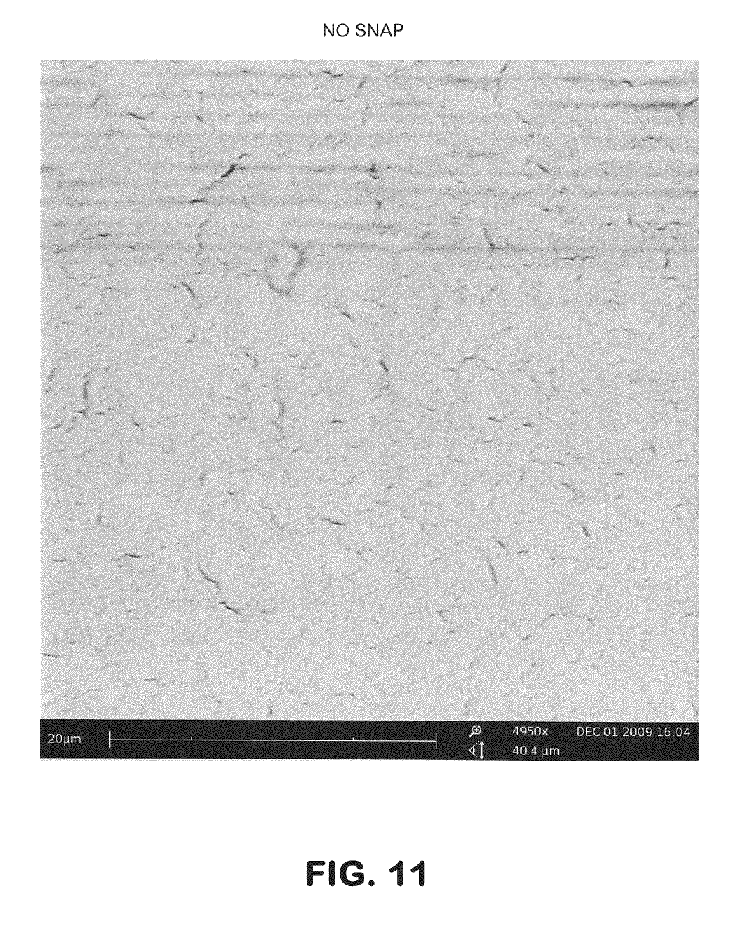

FIG. 11 is a scanning electron micrograph illustrating the cut end of the analytical instrument tubing formed with PEEK after the second cut is made using the apparatus and methods disclosed herein. The cut end after the second cut has a substantially flat cross-sectional area that is substantially defect free and contains no snap lines. The image of the cross-sectional surface in the micrograph has a magnification of 4950×. As demonstrated by a comparison of the scanning electron micrographs illustrated in FIGS. 10 and 11, the cut end of analytical instrument tubing after the second cut using the apparatus and methods disclosed herein has substantially smaller and substantially fewer defects than the cut end of analytical instrument tubing cut using the prior art cutting technique of making a partial cut using a spinning blade and then snapping off the extra segment of tubing.

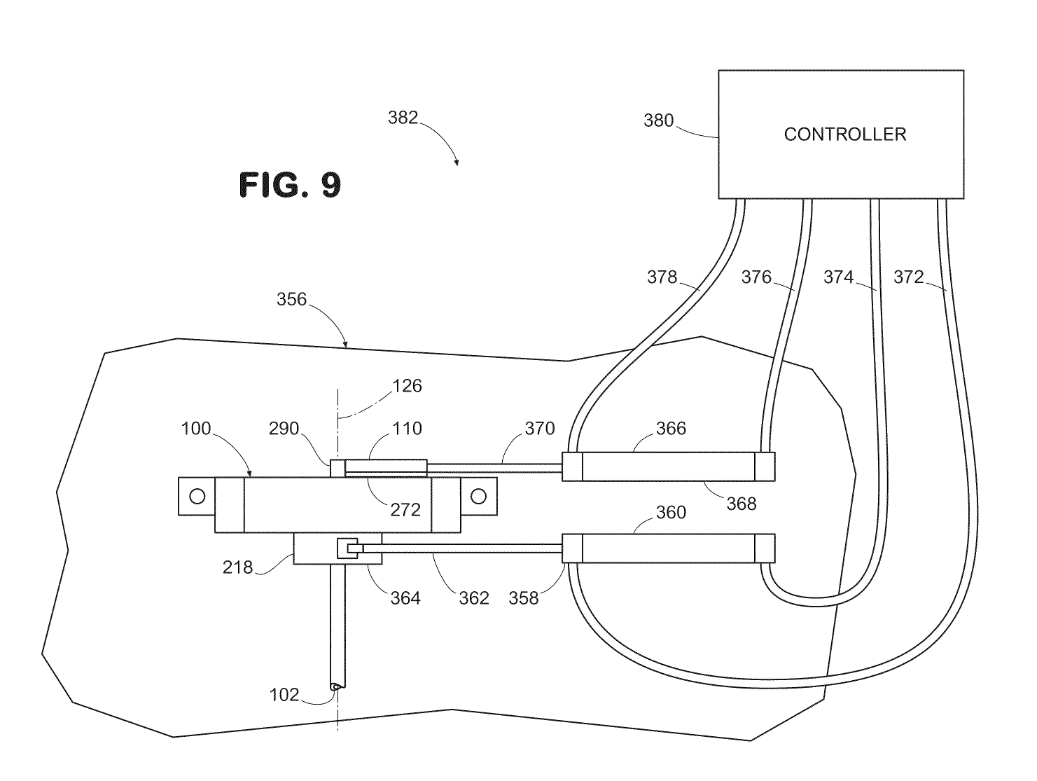

Referring now to FIG. 9, an automated cutting tool 382 includes the cutting tool 100 bolted to a horizontal table top 356. A first actuator 358 has a pneumatic cylinder 360 and a piston rod 362 connected to the clamp member 218 by a pivotable linkage 364. A second actuator 366 has a pneumatic cylinder 368 and a piston rod 370 connected to the cutting assembly 110. Hoses 372 and 374 are connected between a controller 380 and the pneumatic cylinder 360 of the first actuator 358. Hoses 378 and 380 are similarly connected between the controller 380 and the pneumatic cylinder 368 of the second actuator 366. In various embodiments, the automated cutting tool 382 includes a support structure (not shown) to support the portion of tube 102 being fed into the tube passage 214, 242, 254, 262 of the cutting tool 100. In possible embodiment, this support structure supports at least a segment of tube 102 leading into the tube passage 214, 242, 254, 262 in an elevated position off the table top so at least the portion of the tube 102 entering into the tube passage 214, 242, 254, 262 is centered on the centerline 126.

In possible embodiments of the automated cutting tool 382, the tube hole 216 is located between the first side surface 274 of the blade mounting structure 268 and the first side portion 120 of the support structure 104 when the cutting assembly 110 is in the retracted position 294. This embodiment eliminates the need to rotate the cutting assembly 110, which is connected to the piston rod 370, to load or advance the tube 102 between first and second cutting positions. Additionally, the mechanical components of the cutting tool 100 can be reinforced or modified to withstand the force that the first and second actuators 358 and 366 apply to the clamp member 218 and the cutting assembly 110.

The controller 380 can have any type of configuration for controlling the first and second actuators 358 and 366 and can be formed with valves, pumps, filters, fluid reservoirs, and electronics as required. The controller 380 also can include programmable and non-programmable electronics for controlling actions of the mechanical components including computers, solid-state electronics, and mechanical control elements such as relays, timers, latches, switches, and other components. Additionally, alternative embodiments can include any other type of suitable actuators such as hydraulic cylinders, solenoids, motors, and the like.

In use, the tube 102 is mounted on the cutting tool 100 as described herein. The controller 380 actuates the second actuator 366 so the piston rod 370 extends from the pneumatic cylinder 368, which slides the cutting assembly 110 from the retracted position 294 to the extended position 296 and so the blade 272 will make the first cut. The controller 380 then controls the second actuator 366 to retract the piston rod 370 to return the cutting assembly 110 to the retracted position 294. After the cutting assembly 110 is returned to the retracted position 294, the controller 380 controls pneumatic cylinder 360 of the first actuator 358 to extend the piston rod 362 to rotate the clamp member 218 from the first rotational position 358ₐ to the second rotation position 358_{b}. After the clamp member 218 is in the second rotational position 358_{b}, the controller 380 again controls the second pneumatic cylinder to move the cutting assembly 110 from the retracted position 294 to the extend position 296 to make the second cut.

After the second cut, the controller 380 controls the first actuator 358 to return the clamp member to the first rotational position 358ₐ and the second actuator to return the cutting assembly 110 to the retracted position 294. The tube 102 can then be adjusted and the process can be repeated to cut an end on another segment of tubing.

For convenience in explanation and accurate definition in the appended claims, the terms “upper” and “lower”, etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for cutting analytical instrument tubing, comprising:
a blade for cutting a tube; and
a clamp assembly configured to securely hold at least a portion of the tube, the clamp assembly movable between a first position to hold the tube in a first cutting location relative to the blade and a second position to hold the tube in a second cutting position relative to the blade; and
a tube advancement mechanism operably connected to the clamp assembly.

2. An apparatus as recited in claim 1, wherein the blade comprises a material selected from the group consisting of glass, ceramic, steel, stainless steel, and carbon.

3. An apparatus as recited in claim 1, wherein the tubing comprises a material selected from the group consisting of silica, fused silica, silicone, acetal resin, resin, plastic, thermoplastic, semi-crystalline, polycrystalline, metal, ceramic, and a polymeric material.

4. An apparatus as recited in claim 3, wherein the polymeric material comprises a material selected from the group consisting of polyetheretherketone (PEEK), epoxy, polyimide (PI), polytetrafluoroethylene (PTFE), ethylene-chlorotrifluorethylene (ECTFE), polyphenylsulfone (PPSU), ismaprene, fluoroethylene-propylene (FEP), perfluoralkoxy (PFA), ethylene-tetrafluoroethylene-copolymer (ETFE), polyetherimide (PEI), polyamide-imide (PAI), polyphenylene sulfide (PPS), polysulfone (PSU), polypropylene, polyvinyl-fluoride (PVF), polyvinylidene-fluoride (PVDF), polyetherimide (PEI), polyetheretherketone with fused silica, polychlorotrifluoroethylene (PCTFE), polyoxy-methylene, and acetyl polyoxy-methylene.

5. An apparatus as recited in claim 1, wherein the clamp assembly further comprises a support structure operatively connected to the clamp assembly and the tube advancement mechanism.

6. An apparatus as recited in claim 5, further comprising a cutting assembly operatively connected to the support structure, the cutting assembly supporting the blade.

7. An apparatus as recited in claim 6, wherein the cutting assembly is slidably connected to the support structure.

8. An apparatus as recited in claim 8, wherein the cutting assembly is rotatably connected to the support structure.

9. An apparatus as recited in claim 5, wherein the clamp assembly comprises a compression fitting operatively connected to the support structure.

10. An apparatus as recited in claim 9, wherein the compression fitting comprises a ferrule, the ferrule defining a tube passage.

11. An apparatus as recited in claim 9, wherein the clamp assembly further comprises first and second clamp members, the compression fitting being positioned between the first and second clamp members.

12. An apparatus as recited in claim 11, wherein the clamp assembly is rotatably connected to the support structure and is rotatable between at least first and second positions.

13. An apparatus as recited in claim 12, wherein the tube advancement mechanism comprises:
a first helical thread operatively connected to the support structure;
a second helical thread operatively connected to the clamp assembly; and
the first helical thread mates with the second helical thread.

14. An apparatus as recited in claim 1, further comprising a cutting assembly.

15. An apparatus as recited in claim 1, wherein the blade comprises a thickness from about 0.004 to about 0.012 millimeters.

16. An apparatus as recited in claim 1, further comprising a cutting surface, the blade being angled relative to the cutting surface at an about of about 45° or less.

17. An apparatus as recited in claim 1, further comprising a first actuator operatively connected to the blade and a second actuator operatively connected to the tube advancement mechanism.

18. A method for cutting an analytical instrument tube, the analytical instrument tube having a first cross section and a second cross section proximal to the first cross section, the method comprising:
positioning the tube in a first cutting position relative to a cutting edge of a blade;
at least partially cutting the tube across the first cross section to form a first cut surface;
advancing the tube to a second cutting position relative to the cutting edge of the blade; and
cutting the tube across the second cross section of the tube to form a second cut surface, the second cut surface having fewer imperfections than the first cut surface.

19. A method as recited in claim 18, wherein the tube has a centerline and the second cut surface is formed a distance along the centerline spaced from the first cut surface, the distance being in the range of around 0.001 to about 10 millimeters.

20. A method as recited in claim 18, wherein the blade comprises a material selected from the group consisting of glass, ceramic, steel, stainless steel, and carbon.

21. A method as recited in claim 18, wherein the tube comprises a material selected from the group consisting of silica, fused silica, silicone, acetal resin, resin, plastic, thermoplastic, semi-crystalline, polycrystalline, metal, ceramic, and a polymeric material.

22. A method as recited in claim 18, wherein the polymeric material comprises a material selected from the group consisting of polyetheretherketone (PEEK), epoxy, polyimide (PI), polytetrafluoroethylene (PTFE), ethylene-chlorotrifluorethylene (ECTFE), polyphenylsulfone (PPSU), ismaprene, fluoroethylene-propylene (FEP), perfluoralkoxy (PFA), ethylene-tetrafluoroethylene-copolymer (ETFE), polyetherimide (PEI), polyamide-imide (PAI), polyphenylene sulfide (PPS), polysulfone (PSU), polypropylene, polyvinyl-fluoride (PVF), polyvinylidene-fluoride (PVDF), polyetherimide (PEI), polyetheretherketone with fused silica, polychlorotrifluoroethylene (PCTFE), polyoxy-methylene, and acetyl polyoxy-methylene.

23. A method as recited in claim 18, wherein the method is automated.

24. A method as recited in claim 16, wherein the blade comprises a thickness from about 0.004 to about 0.012 millimeters.

25. A method as recited in claim 16, further comprising connecting the tube to an instrument used in ion chromatography.

26. A method as recited in claim 16, further comprising connecting the tube to an instrument used in HPLC.
